(19) United States
(12) Patent Application Publication
(10) Pub. No.: US 2020/0307346 A1
(43) Pub. Date: Oct. 1, 2020

(54) LIQUID-COOLED ENERGY STORAGE ARRANGEMENT

(71) Applicant: Mahle International GmbH, Stuttgart (DE)

(72) Inventors: Thomas Kalmbach, Stuttgart (DE); Mario Wallisch, Aichtal (DE)

(21) Appl. No.: 16/831,774

(22) Filed: Mar. 26, 2020

(30) Foreign Application Priority Data
Mar. 27, 2019 (DE) 102019204270.8

(51) Int. Cl. B60H 1/00

(52) U.S. Cl. CPC B60H 1/00278; B60H 2001/00307; B60H 1/00885

(57) ABSTRACT

A liquid-cooled energy storage arrangement for an electric drive in a motor vehicle may include an energy storage, a volume through which a cooling medium is flowable, and at least one positive pressure discharge member. The energy storage may include a housing, in which a plurality of storage cells may be arranged. The volume may be in heat-conducting contact with the plurality of storage cells. The volume may be limited at least by a cooling medium-guiding feed line and a cooling medium-guiding discharge line. The plurality of storage cells may be structured and arranged to be in direct contact with the cooling medium. The at least one positive pressure discharge member may connect the volume to a surrounding area, and may be configured to open at a predefined pressure. The at least one positive pressure discharge member may be arranged in one of the feed line and the discharge line.

### CROSS-REFERENCE TO RELATED APPLICATIONS

This application claims priority to German Patent Application No. DE 10 2019 204 270.8, filed on Mar. 27, 2019, the contents of which are hereby incorporated by reference in their entirety.

### TECHNICAL FIELD

The present invention relates to a liquid-cooled energy storage arrangement for an electric drive in a motor vehicle. The invention furthermore relates to a liquid-cooled energy storage for an energy storage arrangement of this type as well as to an electric vehicle comprising an energy storage arrangement of this type or an energy storage of this type.

### BACKGROUND

Generic liquid-cooled energy storage arrangements for electric vehicles are well known. A problem case when operating energy storage arrangements of this type occurs, for example, in the case of a so-called thermal runaway of lithium-ion storage cells, which, in a critical state, dissipate a significant amount of hot gas within a very short time, which has to be discharged reliably. For this purpose, small openings, for example, which are initially closed and which open, starting at a predefined pressure, so as to then provide a sufficiently large cross section for discharging the hot gases from the energy storage or from the storage cells, respectively, can be provided. The opening pressure provided for this purpose, however, has to always be below a failure or bursting pressure, respectively, of a housing or of a cooling medium circuit, respectively, so as to be able to reliably rule out an uncontrolled bursting of the housing or of the cooling medium circuit, respectively, at a different location. In this context, the outlet cross section also has to be designed in such a way that the system pressure or internal pressure, respectively, remains below the bursting pressure of the housing or of the circuit, respectively, at any time. This means also in the case, in which the openings are open. In the case of directly liquid-cooled energy storages, the outlet openings additionally have to remain closed during normal operation and must neither allow fluid, that is, cooling medium, nor gas to pass through. In the case of the irreversible gas escape from the energy storage cells, however, the sudden opening and allowing gas or a gas-liquid mixture, respectively, to pass through the openings is required.

It is a disadvantage of the energy storage known from the prior art, however, that an aperture has to be arranged in the cooling device/cooling plate/cooling volume limitation at every energy storage cell, which is complex and expensive. It is furthermore a disadvantage of this prior art that each individual interconnection of each cell to the cooling volume (even in the case of thermal runaway) has to be tight and that gas must only go through this opening and only into the externally arranged cooling fluid. If an aperture is arranged, for example, centrally above energy storage cells, this can make the path of the gas from the energy storage cell to the discharge member or to the opening, respectively, more difficult or can prevent it, respectively, in the venting case, whereby a back-pressure, a pressure build-up or an inflating of the housing or, in the worst case, even a tearing of said housing can occur. A venting path, which is to be provided for this purpose, would furthermore need to be blocked or at least made more difficult, respectively, during normal operation, because a bypass can otherwise occur for the cooling medium, whereby a sufficient or reliable cooling, respectively, of the individual energy storage cells may sometimes no longer take place.

### SUMMARY

The present invention thus deals with the problem of specifying an improved or at least an alternative embodiment for an energy storage arrangement of the generic type, which overcomes in particular the disadvantages known from the prior art.

This problem is solved according to the invention by means of the subject matter of the independent claim(s). Advantageous embodiments are the subject matter of the dependent claim(s).

The present invention is based on the general idea of no longer arranging a positive pressure discharge member for the sudden venting of energy storage cells at a central position above a cell pack, as currently known from the prior art, but at a different location in the region of a cooling medium circuit, which, on the one hand, provides for the arrangement of significantly fewer positive pressure discharge members, for example only one positive pressure discharge member, and which, on the other hand, reliably rules out the risk of a cooling medium bypass. For this reason, at least one positive pressure discharge member is arranged in a cooling medium-guiding feed line or in a cooling medium-guiding discharge line. The liquid-cooled energy storage arrangement according to the invention for an electric drive in a motor vehicle, in particular an electric vehicle, thereby has an energy storage comprising a housing, in which several storage cells are arranged, for example upright. The storage cells are thereby at least partially surrounded by a volume, through which a cooling medium can flow, so that the storage cells are in heat-conducting contact with this volume. The volume is thereby limited at least by the above-mentioned cooling medium-guiding feed line and the cooling medium-guiding discharge line. Cooling medium is thereby applied directly to the storage cells and they are thus in direct contact with said cooling medium. A cooling medium-containing collector, a distributor or a compensating container can likewise be provided. According to the invention, at least one positive pressure discharge member is now provided, which opens, starting at a predefined pressure in the cooling medium, and which thus connects the volume to the surrounding area, wherein cooling medium and/or gas can reach via the positive pressure discharge member into the surrounding area in this case. The at least one positive pressure discharge member is thereby arranged in the feed line or the discharge line. The number of the required positive pressure discharge members can thus be significantly reduced by means of the energy storage arrangement according to the invention, wherein, at best, only a single positive pressure discharge member is still provided, whereby the design of the energy storage arrangement can be simplified significantly and can thus be designed significantly more cost-efficiently. Spaces or flow ducts, respectively, of the cooling medium, which are currently free, can additionally be used for the gas or gas-liquid mixture, respectively, so that no specific and in particular additional ducts are required for a venting gas of this type or for the case of exhaust gas removal from the storage cells, respectively. It is furthermore particularly advantageous that there is no risk of a bypass flow of the cooling medium along the flow paths, which are additionally provided for the gas, due to the arrangement according to the invention of the positive pressure discharge member in the region of the feed line, the discharge line, the collector, the distributor or the compensating container.

The at least one positive pressure discharge member is thereby advantageously arranged in the cooling medium-guiding discharge line, because a lower pressure prevails here than in the feed line, whereby it is possible to be able to select the opening pressure for the positive pressure discharge member closer to a bursting pressure of the housing. If possible, no further or at least only a few built-in components, respectively, which can generate a pressure loss, in the cooling medium circuit are to thereby be provided in the discharge line downstream from the positive pressure discharge member, because said built-in components would additionally increase the cooling medium pressure in the energy storage, which, in turn, has a negative impact on the opening pressure of the positive pressure discharge member. The positive pressure discharge member is thereby preferably arranged, for example in the discharge line, in such a way that, in response to a sudden removal of exhaust gas from a storage cell and an opening of the positive pressure discharge member associated therewith, liquid escaping there or gas escaping there, respectively, does not endanger any structures of the energy storage arrangement or of the electric vehicle, respectively, or a person located in the surrounding area.

In the case of an advantageous further development of the solution according to the invention, the positive pressure discharge member is formed as bursting disk, as predetermined breaking point, as liquid-tight film or as pressure relief valve, in particular as back-pressure valve. A bursting disk or liquid-tight film, respectively, of this type or generally a predetermined breaking point thus breaks in the case of a predefined positive pressure, and thus provides for a discharge of cooling medium or gas, respectively, without having to fear a bursting of the housing. After the tearing, however, an automatic closing of a bursting disk or film/predetermined breaking point of this type is no longer possible. If, in contrast, the positive pressure discharge member is formed as pressure relief valve, for example as back-pressure valve, it can discharge the resulting positive pressure even in response to a sudden exhaust gas removal from a storage cell, and subsequently closes tightly again, whereby an uncontrolled escape of cooling medium or gas, respectively, can be reliably avoided after the pressure compensation. The currently installed positive pressure discharge member could still be used in this case, for example after a replacement of the storage cell, from which exhaust gas was removed, and would not also need to be replaced, whereby a significant reduction of the repair costs can be attained.

Advantageously, a cooling medium-containing collector and/or a cooling medium-containing distributor and/or a compensating container are/is provided, wherein at least one positive pressure discharge member is arranged in the collector, the distributor or the compensating container. This demonstrates a high flexibility of the arrangement options of the positive pressure discharge member, so that it can in particular also be installed at installation locations, which were previously not possible.

A protective device, which is connected upstream of the positive pressure discharge member and which in particular prevents a blocking of the positive pressure discharge member, is advantageously provided. A protective device of this type can be, for example, a mesh or a filter, which makes it possible to retain solid components, which detach somewhere, for example from the housing, for example in response to the thermal runaway, that is in response to the sudden removal of exhaust gas from an energy storage cell. Due to the protective device, it can thus be effectively prevented that a housing component of this type, which detaches in response to the removal of exhaust gas, penetrates into the positive pressure discharge member and effects a blocking of the latter there, and prevents a further reduction of the positive pressure.

In the case of a further advantageous embodiment of the solution according to the invention, a collecting device for collecting cooling medium when the positive pressure discharge member is open is provided downstream from the at least one positive pressure discharge member. A collecting device of this type can be formed, for example, as simple collecting tray and can reliably prevent an uncontrolled escape of cooling medium into the surrounding area.

Advantageously, a pump for conveying the cooling medium is provided, which is impermeable for cooling medium in the turned-off state. A pump of this type provides the large advantage that the cooling medium circuit can usually not idle completely in response to a suddenly occurring removal of exhaust gas from a storage cell and thus in response to an opening of the positive pressure discharge member, because the pump represents a natural barrier for the cooling medium in the turned-off state.

The present invention is further based on the general idea of specifying a liquid-cooled energy storage comprising a housing, in which several directly liquid-cooled storage cells are arranged. A volume, which is in heat-conducting contact with the storage cells and through which cooling medium can flow, is likewise provided, wherein this volume is limited at least by a cooling medium-supplying feed line and a cooling medium-guiding discharge line, and optionally by a cooling medium-containing collector and/or a cooling medium-containing distributor. The energy storage according to the invention thereby has at least one positive pressure discharge member, which opens, starting at a predefined pressure in the cooling medium, for example due to a sudden exhaust gas removal from a storage cell, and which connects the volume to the surrounding area, wherein this positive pressure discharge member is arranged in the feed line or the discharge line and optionally in the collector or the distributor. It goes without saying that it is clear thereby that only a single positive pressure discharge member of this type is already sufficient, so as to prevent a bursting of the housing in response to a suddenly occurring exhaust gas removal from a storage cell, that is, in the case of a defect of said storage cell, whereby it goes without saying that more than one positive pressure discharge member of this type can also be provided. The advantage of a liquid-cooled energy storage of this type according to the invention is that the positive pressure discharge member is firmly arranged on the energy storage and is thus also operational in the case of an energy storage, which is separated from the cooling medium circuit, for example in response to the recycling or a storage thereof, respectively.

The at least one positive pressure discharge member is thereby preferably arranged in the region of the discharge line, that is, a cooling medium-guiding return line, because lower pressures are present here than for example in the feed line, and the opening pressure can thus be selected more closely to the bursting pressure of the housing.

In the case of an advantageous further development of the energy storage according to the invention, the positive pressure discharge member is formed as bursting disk, as predetermined breaking point, as liquid-tight film or as pressure relief valve, in particular as back-pressure valve. A bursting disk or liquid-tight film of this type, respectively, thus breaks at a predefined positive pressure and thus provides for a discharge of cooling medium or gas, respectively, without having to fear a bursting of the housing. After the tearing, however, an automatic closing of a bursting disk or film of this type is no longer possible. If, in contrast, the positive pressure discharge member is formed as pressure relief valve, for example as back-pressure valve, it can discharge the resulting positive pressure even in response to a sudden exhaust gas removal from a storage cell, and subsequently closes tightly again, whereby an uncontrolled escape of cooling medium or gas, respectively, after the pressure compensation can be reliably avoided. The currently installed positive pressure discharge member could still be used in this case, for example after a replacement of the storage cell, from which exhaust gas was removed, and would also not need to be replaced, whereby a significant reduction of the repair costs can be attained.

Advantageously, the energy storage according to the invention has a protective device, which is connected upstream of the positive pressure discharge member and which in particular prevents a blocking of the positive pressure discharge member. A protective device of this type can be, for example, a mesh or a filter, which makes it possible to retain solid components, which detach somewhere, for example from the housing, for example in response to the thermal runaway, that is in response to the sudden removal of exhaust gas from an energy storage cell. Due to the protective device, it can thus be effectively prevented that a housing component of this type, which detaches in response to the removal of exhaust gas, penetrates into the positive pressure discharge member and effects a blocking of the latter there, and prevents a further reduction of the positive pressure.

In the case of a further advantageous embodiment of the energy storage according to the invention, a collecting device for collecting cooling medium when the positive pressure discharge member is open is provided downstream from the at least one positive pressure discharge member. A collecting device of this type can be formed, for example, as simple collecting tray and can reliably prevent an uncontrolled escape of cooling medium into the surrounding area.

The present invention is further based on the general idea of equipping an electric vehicle with an above-described liquid-cooled energy storage arrangement or with an above-described liquid-cooled energy storage, and thus be able to transfer the above-described advantages to the electric vehicle.

Further important features and advantages of the invention follow from the subclaims, from the drawings, and from the corresponding figure description on the basis of the drawings.

It goes without saying that the above-mentioned features and the features, which will be described below, cannot only be used in the respective specified combination, but also in other combinations or alone, without leaving the scope of the present invention.

Preferred exemplary embodiments of the invention are illustrated in the drawings and will be described in more detail in the following description, whereby identical reference numerals refer to identical or similar or functionally identical components.

### BRIEF DESCRIPTION OF THE DRAWINGS

In each case schematically,

FIG. 1 shows a liquid-cooled energy storage arrangement according to the invention comprising a positive pressure discharge member in a discharge line,

FIG. 2 shows an energy storage according to the invention comprising a positive pressure discharge member in a collector or distributor, respectively.

### DETAILED DESCRIPTION

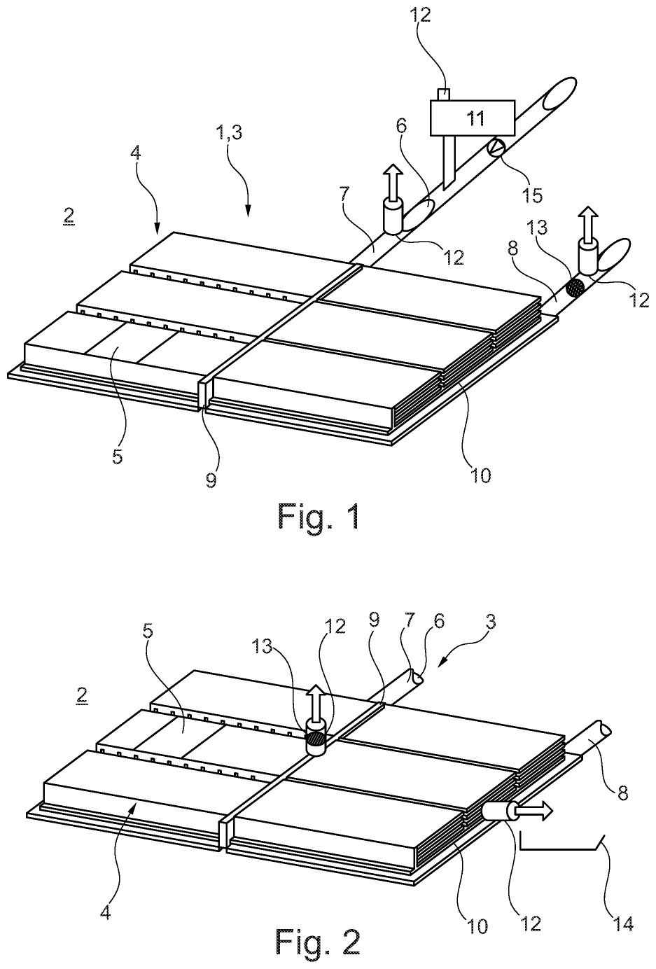

According to FIG. 1, a liquid-cooled energy storage arrangement 1 according to the invention for an electric drive in, for example, an electric vehicle 2 has at least one electric energy storage 3 (see also FIG. 2) comprising a housing 4, in which several directly liquid-cooled storage cells 5 are arranged. The storage cells 5 are thereby in heat-conducting, in particular heat-transferring, contact with a volume 6, which is limited by at least one cooling medium-guiding feed line 7 and a cooling medium-guiding discharge line 8 as well as optionally a cooling medium-containing collector 10 and/or a cooling medium-containing distributor 9. In addition, a compensating container 11, which is connected to the feed line 7 and/or the discharge line 8, can also be provided.

According to the invention, at least one positive pressure discharge member 12 is now provided, which opens, starting at a predefined pressure in the cooling medium, and which thus connects the volume 6 to the surrounding area. According to the invention, the at least one positive pressure discharge member 12 is thereby arranged in the feed line 7 or the discharge line 8 and in particular optionally the collector 10, the distributor 9 or the compensating container 11.

According to FIG. 1, the energy storage arrangement 1 is thereby identified with the same arrow as the energy storage 3, whereby it goes without saying that it is conceivable that the above and below descriptions apply to the energy storage 3 as separate unit as well as to the energy storage 3 as a part of the energy storage arrangement 1. The energy storage arrangement 1 according to the invention can thus in particular also relate to the energy storage arrangement 1 according to the invention as well as to several energy storages 3, which each comprise a housing 4 and storage cells 5 arranged therein, wherein the feed line 7 and the discharge line 8 are connected to the energy storage arrangement 1 or to the energy storage 3, respectively. The distributor 9 or the collector 10, respectively, can thereby also be part of the energy storage arrangement 1 or of a separate energy storage 3.

The positive pressure discharge member 12 according to the invention can generally be formed as bursting disk, as predetermined breaking point, as liquid-tight film or as pressure relief valve, in particular as back-pressure valve. In the case of a bursting disk or liquid-tight film, respectively, a predefined positive pressure causes an irreversible tearing thereof, so that the entire energy storage arrangement 1 or the entire energy storage 3, respectively, subsequently seals again in the region of the positive pressure discharge member 12 or the latter has to be replaced, respectively. In contrast, if the positive pressure discharge member 12 is formed as pressure relief valve, in particular as back-pressure valve, a sudden reduction of the positive pressure can take place in response to a sudden exhaust gas removal from a storage cell 5, for example in response to a thermal runaway, wherein the positive pressure discharge member 12, which is formed as pressure relief valve, closes again and does not allow a further scape of cooling medium or gas into the surrounding area after a pressure compensation. Only the defective storage cell 5 would need to be replaced in this case and cooling medium, which may have escaped, would need to be refilled.

A protective device 13, which is connected upstream of the positive pressure discharge member 12 and which in particular prevents a blocking of the positive pressure discharge member 12, is advantageously provided. A protective device 13 of this type can be, for example, a mesh or a filter, as it is illustrated in a roughly schematic manner according to FIG. 1. In particular a blocking of the positive pressure discharge member 12 caused by housing parts or other parts, which break off in response to the sudden exhaust gas removal from or venting of, respectively, a storage cell 5 can be prevented thereby. A collecting device 14 (see FIG. 2) for collecting cooling medium when the positive pressure discharge member 12 is open, is thereby preferably provided downstream from the at least one positive pressure discharge member 12. In particular an uncontrolled escape of cooling medium via the positive pressure discharge member 12 into the surrounding area can thereby be prevented in the case of venting.

A pump 15, which is impermeable for cooling medium in the turned-off state, can likewise be provided for conveying the cooling medium. This offers the large advantage that, after a case of venting and in response to an irreversible opening of the positive pressure discharge member 12, a complete idling of a cooling medium circuit can be prevented at least on the part of the pump 15, because the latter is fluid-tight, that is impermeable for cooling medium, in the turned-off state.

As already described above, not only the entire energy storage arrangement 1 is to be protected with the present invention, but also a separate energy storage 3, which has, for example, a separate housing 4, in which several storage cells 5 are arranged. To be able to cool the storage cells 5, a volume 6 is provided, which is in heat-transferring contact therewith and through which cooling medium flows, wherein this volume 6 is limited at least by a cooling medium-guiding feed line 7, a cooling medium-guiding discharge line 8, a cooling medium-containing collector 10, and/or a cooling medium-containing distributor 9. The liquid-cooled energy storage 3 according to the invention thereby has at least one positive pressure discharge member 12, which opens, starting at a predefined pressure in the cooling medium and connects the volume 6 to the surrounding area, wherein the at least one positive pressure discharge member 12 is arranged in the feed line 7 or the discharge line 8 or optionally in the collector 10 or the distributor 9, respectively.

The large advantage of the energy storage 3 according to the invention is that the positive pressure discharge member 12 is part of the energy storage 3 and can thus also be protected in response to a sudden venting of a storage cell 5 when not installed in an electric vehicle 2. The positive pressure discharge member 12 thus also remains fully functional in this case even in the case of a storage or in the case of a recycling, respectively, of the energy storage 3 according to the invention.

In the case of an advantageous further development of the energy storage 3 according to the invention, a protective device 13, which is connected upstream of the positive pressure discharge member 12, is provided, which prevents a blocking of the positive pressure discharge member 12. A protective device 13 of this type can be formed, for example, as protective mesh or as filter, and can even be part of the positive pressure discharge member 12 in a particularly preferred case, as is illustrated according to FIG. 2. In the alternative, it is also conceivable thereby that the protective device 13, as it is shown according to FIG. 1, is arranged upstream of the positive pressure discharge member 12 in the discharge line 8. A protective device 13 of this type is to in particular prevent an unwanted penetration of broken-off parts into the positive pressure discharge member 12, which may for example have the result that the open passage cross section thereof is no longer completely available.

The at least one positive pressure discharge member 12 is thereby preferably arranged in the discharge line 8, because a lower pressure prevails in the latter than in the feed line 7, and the opening pressure of the positive pressure discharge member 12 can thus be selected more closely to the bursting pressure of the housing 4. It should thereby preferably also be ensured that no further or as few further built-in components as possible, respectively, are arranged in the discharge line 8 downstream from the positive pressure discharge member 12 in the discharge line 8, which generate a pressure loss, because they would otherwise additionally increase a cooling medium pressure in the energy storage 3, which, in turn, has a negative impact on the opening pressure of the positive pressure discharge member 12.

In particular the number of required positive pressure discharge members 12 as compared to the solutions known from the prior art can be significantly reduced by means of the energy storage 3 according to the invention and the energy storage arrangement 1 according to the invention, namely preferably to only one single positive pressure discharge member 12, whereby spaces and flow ducts, for example the feed line 7 or the discharge line 8, which are currently not used or provided, respectively, for the gas flow/gas-liquid mixture flow, can be used for the gas or gas-fluid mixture, respectively, and a risk of a bypass flow of the cooling medium along a flow path, which is currently only provided for removing an exhaust gas, has to simultaneously also not be feared. It goes without saying that several positive pressure discharge members 12 of this type can thereby also be provided, as it is illustrated according to FIGS. 1 and 2. Due to the elimination of the additional flow paths and spaces/volumes provided for an exhaust gas removal, the liquid volume in the battery is also reduced, if these spaces were otherwise filled with liquid during normal operation.

1. A liquid-cooled energy storage arrangement for an electric drive in a motor vehicle, comprising:
an energy storage including a housing, in which a plurality of storage cells are arranged;
a volume in heat-conducting contact with the plurality of storage cells and through which a cooling medium is flowable, the volume limited at least by a cooling medium-guiding feed line and a cooling medium-guiding discharge line;
the plurality of storage cells structured and arranged to be in direct contact with the cooling medium;
at least one positive pressure discharge member connecting the volume to a surrounding area, the at least one positive pressure discharge member configured to open at a predefined pressure in the cooling medium; and
wherein the at least one positive pressure discharge member is arranged in at least one of the feed line and the discharge line.

2. The liquid-cooled energy storage arrangement according to claim 1, wherein the at least one positive pressure discharge member is structured as at least one of a bursting disk, a predetermined breaking point, a liquid-tight film, and a pressure relief valve.

3. The liquid-cooled energy storage arrangement according to claim 1, further comprising a protective device connected upstream of the at least one positive pressure discharge member, the protective device structured and arranged to prevent a blocking of the at least one positive pressure discharge member.

4. The liquid-cooled energy storage arrangement according to claim 1, further comprising a collecting device for collecting the cooling medium when the at least one positive pressure discharge member is open, the collecting device disposed downstream from the at least one positive pressure discharge member.

5. The liquid-cooled energy storage arrangement according to claim 1, further comprising a pump configured to convey the cooling medium wherein the pump is impermeable by the cooling medium when in a turned-off state.

6. The liquid-cooled energy storage arrangement according to claim 1, further comprising at least one of a cooling medium-containing collector, a cooling medium-containing distributor, and a compensating container, wherein the at least one positive pressure discharge member is arranged in the at least one of the collector, the distributor, and the compensating container.

7. A liquid-cooled energy storage for an energy storage arrangement, comprising:
a housing;
a plurality of storage cells arranged in the housing;
a volume in heat-conducting contact with the plurality of storage cells and through which a cooling medium is flowable, the volume limited at least by a cooling medium-guiding feed line and a cooling medium-guiding discharge line;
at least one positive pressure discharge member connecting the volume to a surrounding area, the at least one positive pressure discharge member configured to open at a predefined pressure in the cooling medium; and
wherein the at least one positive pressure discharge member is arranged in at least one of the feed line and the discharge line.

8. The liquid-cooled energy storage according to claim 7, wherein the at least one positive pressure discharge member is structured as at least one of a bursting disk, a predetermined breaking point, a liquid-tight film, and a pressure relief valve.

9. The liquid-cooled energy storage according to claim 7, further comprising a protective device connected upstream of the at least one positive pressure discharge member, wherein the protective device is structured and arranged to prevent a blocking of the at least one positive pressure discharge member.

10. The liquid-cooled energy storage according to claim 7 to, further comprising a collecting device for collecting the cooling medium when the at least one positive pressure discharge member is open, the collecting device disposed downstream from the at least one positive pressure discharge member.

11. The liquid-cooled energy storage according to claim 7 to, further comprising at least one of a cooling medium-containing collector and a cooling medium-containing distributor, wherein the at least one positive pressure discharge member is arranged in the at least one of the collector and the distributor.

12. An electric vehicle, comprising a liquid-cooled energy storage arrangement including:
a liquid-cooled energy storage including a housing, in which a plurality of storage cells are arranged;
a volume in heat-conducting contact with the plurality of storage cells and through which a cooling medium is flowable, the volume limited at least by a cooling medium-guiding feed line and a cooling medium-guiding discharge line;
the plurality of storage cells structured and arranged to be in direct contact with the cooling medium;
at least one positive pressure discharge member connecting the volume to a surrounding area, the at least one positive pressure discharge member configured to open at a predefined pressure in the cooling medium; and
wherein the at least one positive pressure discharge member is arranged in one of the feed line and the discharge line.

13. The electric vehicle according to claim 12, wherein the at least one positive pressure discharge member is structured as at least one of a bursting disk, a predetermined breaking point, a liquid-tight film, and a pressure relief valve.

14. The electric vehicle according to claim 12, wherein the energy storage arrangement further includes a protective device connected upstream of the at least one positive pressure discharge member, the protective device structured and arranged to prevent a blocking of the at least one positive pressure discharge member.

15. The electric vehicle according to claim 12, wherein the energy storage arrangement further includes a collecting device for collecting the cooling medium when the at least one positive pressure discharge member is open, the collecting device disposed downstream from the at least one positive pressure discharge member.

16. The electric vehicle according to claim 12, wherein the energy storage arrangement further includes a pump configured to convey the cooling medium, wherein the pump is impermeable by the cooling medium when in a turned-off state.

17. The electric vehicle according to claim 12, wherein the energy storage arrangement further includes at least one of a cooling medium-containing collector, a cooling medium-containing distributor, and a compensating container, wherein the at least one positive pressure discharge member is arranged in the at least one of the collector, the distributor, and the compensating container.

18. The liquid-cooled energy storage arrangement according to claim 1, further comprising a cooling medium-containing collector, wherein the at least one positive pressure discharge member is arranged in the collector.

19. The liquid-cooled energy storage arrangement according to claim 1, further comprising a cooling medium-containing distributor, wherein the at least one positive pressure discharge member is arranged in the distributor.

20. The liquid-cooled energy storage arrangement according to claim 1, further comprising a compensating container, wherein the at least one positive pressure discharge member is arranged in the compensating container.
